(19) United States
(12) Patent Application Publication
(10) Pub. No.: US 2018/0205114 A1
(43) Pub. Date: Jul. 19, 2018

(54) POROUS CELLULOSIC SUBSTRATES FOR LITHIUM ION BATTERY ELECTRODES

(71) Applicants: GM Global Technology Operations LLC, Detroit, MI (US); McMaster University, Hamilton (CA)

(72) Inventors: Allen D. Pauric, Hamilton (CA); Meng Jiang, Rochester Hills, MI (US); Gillian R. Goward, Hamilton (CA); Raghunathan K, Troy, MI (US)

(73) Assignees: GM Global Technology Operations LLC, Detroit, MI (US); McMaster University, Hamilton (CA)

(21) Appl. No.: 15/406,423

(22) Filed: Jan. 13, 2017

(51) Int. Cl. H01M 10/0525; H01M 4/134; H01M 4/131; H01M 4/38; H01M 4/52; H01M 4/48; H01M 4/62; H01M 4/80; H01M 4/66; H01M 4/04

(52) U.S. Cl. CPC H01M 10/0525; H01M 2220/20; H01M 4/131; H01M 4/386; H01M 4/523; H01M 4/483; H01M 4/387; H01M 4/625; H01M 4/626; H01M 4/622; H01M 4/80; H01M 4/66; H01M 4/0404; H01M 4/0471; H01M 4/0428; H01M 4/0423; H01M 2220/30; H01M 4/134

(57) ABSTRACT

An electrode material for an electrochemical cell is provided. The electrode includes a porous hydrophilic substrate, an electroactive material, and a binder. The porous hydrophilic substrate includes a plurality of voids and may be formed from cellulose or cellulosic derivative material. The electroactive material is dispersed in at least a portion of the voids of the hydrophilic substrate. In other aspects, another electrode material for an electrochemical cell is provided. The electrode includes a porous hydrophilic substrate, an electroactive material, an electrically conductive particle, and a binder. The porous hydrophilic substrate includes a plurality of voids and may be formed from cellulose or cellulosic derivative material. The electroactive material and the electrically conductive particle are dispersed in at least a portion of the voids of the hydrophilic substrate. In still other aspects, the porous hydrophilic substrate comprises a coating that is electrically conductive.

This section provides background information related to the present disclosure which is not necessarily prior art.

The present disclosure pertains to electrochemical cells, such as lithium ion batteries, having improved porous substrate frameworks comprising cellulose or derivatives thereof that form electrodes, as well as methods of forming such electrodes.

High-energy density, electrochemical cells, such as lithium ion batteries can be used in a variety of consumer products and vehicles, such as Hybrid Electric Vehicles (HEVs) and Electric Vehicles (EVs). Typical lithium ion batteries include a first electrode (e.g., a cathode), a second electrode of opposite polarity (e.g., an anode), an electrolyte material, and a separator. Conventional lithium ion batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (positive electrode) to an anode (negative electrode) during charging of the battery, and in the opposite direction when discharging the battery. For convenience, a negative electrode will be used synonymously with an anode, although as recognized by those of skill in the art, during certain phases of lithium ion cycling the anode function may be associated with the positive electrode rather than negative electrode (e.g., the negative electrode may be an anode on discharge and a cathode on charge).

In various aspects, an electrode includes an electroactive material. Negative electrodes typically include such an electroactive material that is capable of functioning as a lithium host material serving as a negative terminal of a lithium ion battery. Conventional negative electrodes include the electroactive lithium host material and optionally another electrically conductive material, such as carbon black particles, as well as one or more polymeric binder materials to hold the lithium host material and electrically conductive particles together.

Typical electroactive materials for forming a negative electrode (e.g., an anode) in a lithium-ion electrochemical cell include lithium-graphite intercalation compounds, lithium-silicon intercalation compounds, lithium-tin intercalation compounds, and lithium alloys. While graphite compounds are most common, recently, anode materials with high specific capacity (in comparison with conventional graphite) are of growing interest. For example, silicon has the highest known theoretical charge capacity for lithium, making it one of the most attractive alternatives to graphite as a negative electrode material for rechargeable lithium ion batteries. However, current silicon anode materials suffer from significant drawbacks. Silicon-containing materials experience large volume changes (e.g., volume expansion/contraction) during lithium insertion/extraction (e.g., intercalation and deintercalation). Thus, cracking of the negative electrode (e.g., anode), a decline of electrochemical cyclic performance and large Coulombic charge capacity loss (capacity fade), and extremely limited cycle life are often observed during cycling of conventional silicon-containing electrodes. This diminished performance is believed in large part to be due to the breakdown of physical contact between silicon particles and conductive fillers caused by the large volume changes in the electrode during cycling of lithium ion.

It would be desirable to develop high performance negative electrode materials comprising silicon or other electroactive materials that suffer from large volumetric changes during use in high power lithium ion batteries, which overcome the current shortcomings that prevent their widespread commercial use, especially in vehicle applications. For long term and effective use, electrode materials are thus desirably capable of minimal capacity fade and maximized charge capacity for long-term use in lithium ion batteries.

### SUMMARY

This section provides a general summary of the disclosure, and is not a comprehensive disclosure of its full scope or all of its features.

The present disclosure relates to lithium-ion electrochemical cells, and more specifically to improved electrode (e.g., negative electrode or anode) materials for electrochemical cells.

In various aspects, the present disclosure provides an electrode material for an electrochemical cell. The electrode material includes a porous hydrophilic substrate, an electroactive material, and a binder. The porous hydrophilic substrate includes a plurality of voids. The electroactive material is dispersed in at least some of the voids of the porous hydrophilic substrate.

In various other aspects, the present disclosure provides an electrode material for an electrochemical cell. The electrode material includes a porous hydrophilic substrate, an electroactive material, an electrically conductive particle, and a binder. The porous hydrophilic substrate includes a plurality of voids. The electroactive material and the electrically conductive particle are dispersed in at least some of the voids of the porous hydrophilic substrate.

In certain variations, the porous hydrophilic substrate includes cellulose (C₆H₆O₅)ₙ or derivatives thereof.

In still other variations, the porous hydrophilic substrate has a porosity of greater than or equal to about 20 volume % and less than or equal to about 70 volume %.

In still other variations, the electrically conductive particle is selected from the group consisting of: carbon black, graphite, carbon fibers, carbon nanotubes, powdered nickel, metal particles, conductive polymers, and combinations thereof.

In some variations, a surface of the porous hydrophilic substrate is at least partially coated in an electrically conductive material.

In certain other variations, the binder is water soluble and is selected from the group consisting of: sodium alginate, xanthan gum, carboxy methyl cellulose (CMC), polyacrylic acid (PAA), and combinations thereof.

In still other variations, the electroactive material is selected from the group consisting of: silicon (Si), silicon monoxide (SiO), silicon dioxide (SiO₂), SiSn, SiFe, SiSnFe, SiSnAl, SiFeCo, germanium (Ge), germanium oxide (GeO₂), tin (Sn), tin oxide (SnO₂), iron oxide (Fe₂O₃), and iron oxide alloys, and combinations thereof.

In other aspects, the present disclosure provides a lithium-ion electrochemical cell. The electrochemical cell includes a negative electrode, a positive electrode, a separator, and an electrolyte. The negative electrode includes a porous hydrophilic substrate, a negative electroactive material, and a binder. The porous hydrophilic substrate including a plurality of voids, a negative electroactive material, and a binder. The positive electrode includes a positive electroactive material including a transition metal. The negative electroactive material is dispersed in at least some of the voids of the porous hydrophilic substrate.

In other aspects, the present disclosure provides a lithium-ion electrochemical cell. The electrochemical cell includes a negative electrode, a positive electrode, a separator, and an electrolyte. The negative electrode includes a porous hydrophilic substrate including a plurality of voids, a negative electroactive material, an electrically conductive material, and a binder. The positive electrode includes a positive electroactive material including a transition metal. The negative electroactive material and the electrically conductive particle are dispersed in at least some of the voids of the porous hydrophilic substrate. In certain variations, the electrically conductive particle is selected from the group consisting of: carbon black, graphite, carbon fibers, carbon nanotubes, powdered nickel, metal particles, conductive polymers, and combinations thereof.

In other variations, a surface of the porous hydrophilic substrate is at least partially coated in an electrically conductive material.

In still other variations, the negative electrode is capable of an active material loading of greater than or equal to about 7 mAh/cm² and less than or equal to about 11 mAg/cm².

In certain other variations, the negative electrode has a specific capacity of greater than or equal to about 700 mAh/g after 40 cycles of lithium ion intercalation and deintercalation in the negative electrode of the electrochemical cell.

In still other variations, the negative electrode has a thickness of greater than or equal to about 50 μm and less than or equal to about 130 μm.

In certain other aspects, the present disclosure provides a method of making a negative electrode for an electrochemical cell. The method includes applying a slurry to at least one side of a porous hydrophilic substrate to form a coated substrate. The slurry includes water, a binder, and an electroactive material. The method further includes drying the coated substrate to form the negative electrode.

In yet other aspects, the present disclosure provides a method of making a negative electrode for an electrochemical cell. The method includes applying a slurry to at least one side of a porous hydrophilic substrate to form a coated substrate. The slurry includes water, a binder, an electroactive material, and an electrically conductive particle. The method further includes drying the coated substrate to form the negative electrode.

In certain variations, the method further includes forming a slurry. Forming the slurry includes admixing a binder precursor and water to create a binder solution. Forming the slurry also includes admixing the electroactive material and the electrically conductive particle to form a particle admixture. Forming the slurry further includes adding the particle admixture to the binder solution to form the slurry.

In still other variations, forming a coated porous substrate includes applying the slurry to two sides of the porous hydrophilic substrate.

In other variations, the method further includes applying a conductive surface coating to one or more surface regions of the porous hydrophilic substrate in a process selected from the group consisting of: atomic layer deposition (ALD), physical vapor deposition (PVD), chemical vapor deposition (CVD), chemical vapor infiltration, wet chemistry, and combinations thereof.

In other variations, the electroactive material is present in the porous hydrophilic substrate at greater than or equal to about 50% by mass and less than or equal to about 90% by mass of the slurry. The binder is present at greater than or equal to about 0.5% by mass and less than or equal to about 50% by mass of the slurry. The electrically conductive particle is present at greater than or equal to about 0.5% by mass and less than or equal to about 50% by mass of the slurry.

In still other variations, the porous hydrophilic substrate includes cellulose (C₆H₆O₅)ₙ or derivatives thereof.

In certain variations, the electroactive material is selected from the group consisting of: silicon (Si), silicon monoxide (SiO), silicon dioxide (SiO₂), SiSn, SiFe, SiSnFe, SiSnAl, SiFeCo, germanium (Ge), germanium oxide (GeO₂), tin (Sn), tin oxide (SnO₂), iron oxide (Fe₂O₃), alloys, and combinations thereof.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery cell;

FIG. 2 is a detailed schematic of a side view of an electrode material prepared in accordance with certain aspects of the present disclosure having a porous hydrophilic substrate, an electroactive material, a binder, and an electrically conductive material;

FIGS. 3A-3B depict an electrode material prepared in accordance with certain aspects of the present disclosure having an electrically conductive porous hydrophilic substrate, electroactive material, and a binder. FIG. 3A is a detailed schematic view of the electrode material; FIG. 3B is a cross section of the conductive porous hydrophilic substrate.

FIGS. 4A-4B are related to performance data of electrodes from Example 1. FIG. 4A depicts specific capacity of electrodes prepared in accordance with Example 1; FIG. 4B depicts Coulombic efficiency of the electrodes prepared in accordance with Example 1; and

FIG. 5 is related to performance estimates of electrodes from Example 2, which more specifically depicts energy density of electrodes in accordance with Example 2.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may include a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure pertains to high-performance lithium ion electrochemical cells (e.g., lithium-ion batteries) having improved negative electrodes. In certain aspects, the electrodes are negative electrodes (e.g., anodes). In lithium-ion electrochemical cells or batteries, a negative electrode typically includes a lithium insertion material or an alloy host material. As discussed above, electroactive materials for forming a negative electrode or anode include lithium-graphite intercalation compounds, lithium-silicon intercalation compounds, lithium-tin intercalation compounds, and lithium alloys. While graphite compounds are most commonly used, certain anode materials with high specific capacity (in comparison with conventional graphite) are of growing interest. Silicon (Si) is an attractive alternative to graphite as an anode material for rechargeable lithium ion batteries due to its high theoretical capacity. However, a large diminished Coulombic charge capacity (capacity fade) is observed during cycling, as the result of the breakdown of physical contact between silicon material and conductive fillers caused by the large volume change in the electrode (during lithium ion insertion or intercalation and deinsertion or deintercalation). In addition to capacity fade and a decline of electrochemical cyclic performance, the large volume changes (e.g., volume expansion/contraction) of silicon-containing materials during lithium insertion/extraction can result in cracking of the anode and extremely limited cycle life. These challenges, especially capacity fading for silicon-based anodes, have been a barrier to their widespread use in lithium ion batteries.

The present disclosure pertains to improved electrodes for an electrochemical cell, especially improved high-performance negative electrodes for lithium-ion electrochemical cells. In certain aspects, the present disclosure provides an electrode material including a porous hydrophilic substrate with electroactive material and an electrically conductive material dispersed therein. In certain other aspects, the present disclosure contemplates an electrode material including an electrically conductive porous hydrophilic substrate with an electroactive material dispersed therein. More specifically, a porous hydrophilic substrate may have an electrically conductive coating. In still other aspects, the present disclosure further contemplates methods of making such electrodes.

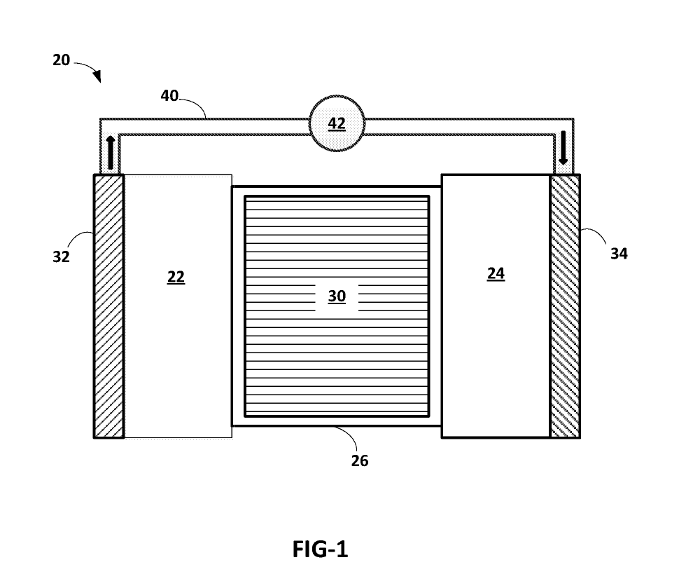

As background, electrochemical cells, especially rechargeable lithium ion batteries, may be used in vehicle or other mobile applications. An exemplary and schematic illustration of a lithium ion battery 20 is shown in FIG. 1. Lithium ion battery 20 includes a negative electrode 22, a positive electrode 24, and a separator 30 (e.g., a microporous polymeric separator) disposed between the two electrodes 22, 24. The separator 26 includes an electrolyte 30, which may also be present in the negative electrode 22 and positive electrode 24. A negative electrode current collector 32 may be positioned at or near the negative electrode 22 and a positive electrode current collector 34 may be positioned at or near the positive electrode 24. The negative electrode current collector 32 and positive electrode current collector 34 respectively collect and move free electrons to and from an external circuit 40. The negative electrode current collector 32 and the positive electrode current collector 34 may be formed from copper or any other appropriate electrically conductive material known to those of skill in the art. An interruptible external circuit 40 and load 42 connects the negative electrode 22 (through its current collector 32) and the positive electrode 24 (through its current collector 34). Each of the negative electrode 22, the positive electrode 24, and the separator 26 may further include the electrolyte 30 capable of conducting lithium ions. The separator 26 operates as both an electrical insulator and a mechanical support, by being sandwiched between the negative electrode 22 and the positive electrode 24 to prevent physical contact and thus, the occurrence of a short circuit. The separator 26, in addition to providing a physical barrier between the two electrodes 22, 24, can provide a minimal resistance path for internal passage of lithium ions (and related anions) for facilitating functioning of the lithium ion battery 20.

The lithium ion battery 20 can generate an electric current during discharge by way of reversible electrochemical reactions that occur when the external circuit 40 is closed (to connect the negative electrode 22 and the positive electrode 34) when the negative electrode 22 contains a relatively greater quantity of intercalated lithium. The chemical potential difference between the positive electrode 24 and the negative electrode 22 drives electrons produced by the oxidation of intercalated lithium at the negative electrode 22 through the external circuit 40 toward the positive electrode 24. Lithium ions, which are also produced at the negative electrode, are concurrently transferred through the electrolyte 30 and separator 26 towards the positive electrode 24. The electrons flow through the external circuit 40 and the lithium ions migrate across the separator 26 in the electrolyte 30 to form intercalated lithium at the positive electrode 24. The electric current passing through the external circuit 40 can be harnessed and directed through the load device 42 until the intercalated lithium in the negative electrode 22 is depleted and the capacity of the lithium ion battery 20 is diminished.

The lithium ion battery 20 can be charged or re-powered at any time by connecting an external power source to the lithium ion battery 20 to reverse the electrochemical reactions that occur during battery discharge. The connection of an external power source to the lithium ion battery 20 compels the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with intercalated lithium for consumption during the next battery discharge cycle. The external power source that may be used to charge the lithium ion battery 20 may vary depending on the size, construction, and particular end-use of the lithium ion battery 20. Some notable and exemplary external power sources include, but are not limited to, an AC wall outlet and a motor vehicle alternator. In many lithium ion battery configurations, each of the negative current collector 32, negative electrode 22, the separator 26, positive electrode 24, and positive current collector 34 are prepared as relatively thin layers (for example, greater than or equal to several microns and less than or equal to about a millimetermicrons in thickness) and assembled in layers connected in electrical parallel arrangement to provide a suitable energy package.

Furthermore, the lithium ion battery 20 can include a variety of other components that while not depicted here are nonetheless known to those of skill in the art. For instance, the lithium ion battery 20 may include a casing, gaskets, terminal caps, and any other conventional components or materials that may be situated within the battery 20, including between or around the negative electrode 22, the positive electrode 24, and/or the separator 26, by way of non-limiting example. As noted above, the size and shape of the lithium ion battery 20 may vary depending on the particular application for which it is designed. Battery-powered vehicles and hand-held consumer electronic devices, for example, are two examples where the lithium ion battery 20 would most likely be designed to different size, capacity, and power-output specifications. The lithium ion battery 20 may also be connected in series or parallel with other similar lithium ion cells or batteries to produce a greater voltage output and power density if it is required by the load device 42.

Accordingly, the lithium ion battery 20 can generate electric current to a load device 42 that can be operatively connected to the external circuit 40. The load device 42 may be powered fully or partially by the electric current passing through the external circuit 40 when the lithium ion battery 20 is discharging. While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the lithium ion battery 20 for purposes of storing energy.

Any appropriate electrolyte 30, whether in solid form or solution, capable of conducting lithium ions between the negative electrode 22 and the positive electrode 24 may be used in the lithium ion battery 20. In certain aspects, the electrolyte solution may be a non-aqueous liquid electrolyte solution that includes a lithium salt dissolved in an organic solvent or a mixture of organic solvents. Numerous conventional non-aqueous liquid electrolyte 30 solutions may be employed in the lithium ion battery 20. A non-limiting list of lithium salts that may be dissolved in an organic solvent to form the non-aqueous liquid electrolyte solution include LiPF₆, LiClO₄, LiAlCl₄, LiI, LiBr, LiSCN, LiBF₄, LiB(C₆H₅)₄, LiAsF₆, LiCF₃SO₃, LiN(CF₃SO₂)₂, and combinations thereof. These and other similar lithium salts may be dissolved in a variety of organic solvents, including but not limited to various alkyl carbonates, such as cyclic carbonates (ethylene carbonate (EC), propylene carbonate (PC), butylene carbonate(BC)), acyclic carbonates (dimethyl carbonate (DMC), diethyl carbonate (DEC), ethylmethylcarbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane), cyclic ethers (tetrahydrofuran, 2-methyltetrahydrofuran), and mixtures thereof.

The separator 30 may include, in one embodiment, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP.

When the separator 30 is a microporous polymeric separator, it may be a single layer or a multi-layer laminate, which may be fabricated from either a dry or wet process. For example, in one embodiment, a single layer of the polyolefin may form the entire microporous polymer separator 30. In other aspects, the separator 30 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 30. The microporous polymer separator 30 may also include other polymers in addition to the polyolefin such as, but not limited to, polyethylene terephthalate (PET), polyvinylidene fluoride (PVDF), and/or a polyamide. The polyolefin layer, and any other optional polymer layers, may further be included in the microporous polymer separator 30 as a fibrous layer to help provide the microporous polymer separator 30 with appropriate structural and porosity characteristics. Various conventionally available polymers and commercial products for forming the separator 30 are contemplated, as well as the many manufacturing methods that may be employed to produce such a microporous polymer separator 30.

The positive electrode 24 may be formed from a lithium-based active material that can sufficiently undergo lithium intercalation and deintercalation while functioning as the positive terminal of the lithium ion battery 20. The positive electrode 24 may also include a polymeric binder material to structurally fortify the lithium-based active material. One exemplary common class of known materials that can be used to form the positive electrode 24 is layered lithium transitional metal oxides. For example, in certain embodiments, the positive electrode 24 may include at least one spinel including a transition metal like lithium manganese oxide (Li₍₁₊ₓ₎Mn₍₂₋ₓ₎O₄), where 0≤x≤1, where x is typically less than 0.15, including LiMn₂O₄, lithium manganese nickel oxide (LiMn₍₂₋ₓ₎NiₓO₄), where 0≤x≤1 (e.g., LiMn_{1.5}Ni_{0.5}O₄), lithium cobalt oxide (LiCoO₂), lithium manganese oxide (LiMn₂O₄), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1, including LiMn_{0.33}Ni_{0.33}C_{0.33}O₂, a lithium nickel cobalt metal oxide (LiNi_{(1-x-y)}CoₓM_{y}O₂), where 0<x<1, y<1, and M may be Al, Mn, or the like, other known lithium-transition metal oxides or mixed oxides lithium iron phosphates, or a lithium iron polyanion oxide such as lithium iron phosphate (LiFePO₄) or lithium iron fluorophosphate (Li₂FePO₄F). Such active materials may be intermingled with a conductive filler material, such as carbon black or graphite, and at least one polymeric binder. Active materials can be slurry cast with other components, including binders like polyvinylidene fluoride (PVDF), ethylene propylene diene monomer (EPDM) rubber, or carboxymethoxyl cellulose (CMC).

In various aspects, the negative electrode 22 includes an electroactive material as a lithium host material capable of functioning as a negative terminal of a lithium ion battery. Lithiation or intercalation of lithium ions in the negative electrode 22 occurs during charge of the electrochemical cell.

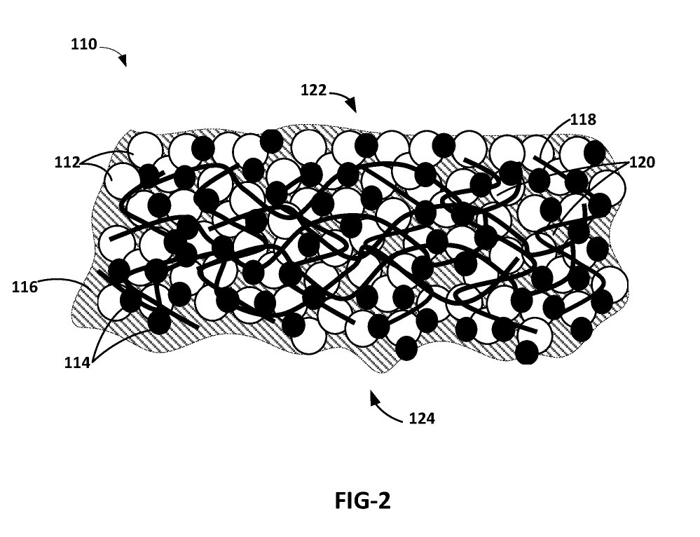

With reference to FIG. 2, a negative electrode 110 includes a negative electroactive material 112, an electrically conductive material 114, and a polymeric binder 116 dispersed in a porous hydrophilic substrate 118. It should be noted that the following discussion and design may also be employed with a positive electrode in alternative variations. The negative electroactive material 112 may include one or more electroactive compounds. In certain variations, the electroactive material may include one or more electroactive compounds that undesirably suffer from significant or substantial volumetric expansion and contraction during lithiation/intercalation and delithiation/deintercalation of lithium ions. The electroactive material 112 may be in the form of solid particles. An electroactive material including silicon is such a composition. Such a material may be silicon (capable of intercalating lithium) or a silicon alloy. Exemplary materials include silicon (Si), silicon monoxide (SiO), and silicon dioxide (SiO₂). Silicon alloys include lithium-silicon and silicon containing binary and ternary alloys, such as SiSn, SiFe SiSnFe, SiSnAl, SiFeCo, and the like. In alternative variations, the present teachings may also be used in conjunction with other electroactive materials 112 that also exhibit significant and undesirable volumetric expansion/contraction during lithiation and delithiation, such as germanium (Ge), germanium oxide (GeO₂), tin (Sn), tin oxide (SnO₂), iron oxide (Fe₂O₃), and iron oxide alloys, and equivalents thereof.

The negative electrode 110 thus includes a lithium host or negative electroactive materials 112 and optionally another electrically conductive material 114, as well as one or more binder materials 116 to structurally hold the lithium host material together. Such negative electrode active materials 112 may be intermingled with the electrically conductive filler material 114 and at least one binder 116. The polymeric binder 116 creates a matrix retaining the negative electrode active materials 112 and electrically conductive filler material 114 in position within the electrode material 110.

The porous hydrophilic substrate 118 is spongy or elastic and defines a plurality of openings or voids 120. It is desirably formed of a material that is electrochemically stable at the electric potentials and conditions experienced in a lithium ion battery. In certain variations, the porous hydrophilic substrate 118 may include cellulose (C₆H₆O₅)ₙ or cellulose derivatives, such as cellulose esters and cellulose ethers. Cellulose esters include: cellulose acetate, cellulose acetate butyrate (CAB), cellulose acetate propionate (CAP), cellulose propionate, and cellulose triacetate, by way of non-limiting example. Cellulose ethers include: carboxymethyl cellulose (CMC), ethylcellulose, ethyl hydroxyethyl cellulose, ethyl methyl cellulose, hydroxyethyl cellulose, hydroxyethyl methyl cellulose, hydroxypropyl cellulose (HPC), hydroxypropyl methyl cellulose (HPMC), and methylcellulose, by way of non-limiting example. The porous hydrophilic substrate 118 may also comprise structural variations of cellulose or cellulose derivatives, such as nanocrystalline cellulose (NCC), nanofibrillar cellulose (NFC), and bacterial cellulose (BC), by way of non-limiting example. Batteries made with such cellulosic materials may be readily recyclable because the cellulosic material can be burned off.

The electrically conductive particle 114 may be any of those described above in the context of FIG. 1, including carbon black, graphite, carbon fibers, carbon nanotubes, powdered nickel, metal particles, conductive polymers, or any combinations thereof. It should be noted that certain materials may fall under the category of electroactive materials or electrically conductive materials and that the categories themselves are not mutually exclusive.

The binder 116 provides electrode integrity by holding the electroactive materials 112 together. The binder 116 also helps maintain contact between the electroactive material 112 and the electrically conductive material 114. In certain variations, the binder 116 may be water soluble. Use of a water-soluble binder 116 enables improved adhesion of the electroactive material 112 and the electrically conductive material 114 to the porous hydrophilic substrate 118. Suitable water soluble-binders include sodium alginate, xanthan gum, carboxymethyl cellulose (CMC), and polyacrylic acid (PAA), by way of non-limiting example.

The electroactive materials 112 and the electrically conductive materials 114 are dispersed in at least some of or a portion of the voids 120. The electroactive materials 112 and the electrically conductive materials 114 may be dispersed in voids 120 throughout the entire substrate 118 and on a first side 122 and a second side 124 of the substrate 118, as shown. In certain aspects, the electroactive materials 112 and the electrically conductive materials 114 may be dispersed in voids 120 in select regions of the substrate 118, for example, only penetrating a body of the substrate 118 a certain distance from the first side 122 or from the second side 124 into the central region, rather than being evenly distributed through the entire body of the substrate 118. In still other aspects, the electroactive materials 112 and the electrically conductive materials 114 may be dispersed almost entirely on the first side 122, almost entirely on the second side 124, or almost entirely on the first and second sides 122, 124. In certain variations, the electroactive materials 112 and the electrically conductive materials 114 may be substantially homogenously dispersed within the void regions of the substrate 118.

As briefly discussed above, there are several challenges associated with the use of electroactive materials that undergo significant volumetric expansion. Multiple cycles of repeated volume expansion and contraction can pulverize the electroactive material and result in separation of the electroactive particles from the electrically conductive particles. This physical instability results in reduced conductivity and disruption in the solid electrolyte interphase (SEI), which plays a role in the kinetics of lithium intercalation. The disruption of the SEI promotes breakdown of the electrolyte, which thickens the SEI layer and results in an increase in electrical resistance and depletion of the electrolyte components.

The spongy or elastic characteristic of the substrate 118 is particularly advantageous for use in a lithium ion battery using electroactive materials that undergo significant volume expansion, such as silicon-containing materials. The electroactive material particles 112 can expand and contract within the voids 120 of the substrate 118. The spongy or webbed structure of the substrate 118 enables expansion and contraction of the electroactive material particles 112 without cracking the substrate 118. As a result, the electroactive materials 112 remain in contact with the electrically conductive particles 114. Thus, the ability of the substrate 118 to expand and contract with lithiation and delithiation reduces the challenges associated with electroactive materials that undergo significant volume expansion.

The above properties result in batteries having improved performance characteristics, such as increased active material loading and higher areal capacity. More specifically, a negative electrode according to certain aspects of the present disclosure may have an active material loading of greater than or equal to about 7 mAh/cm² to less than or equal to about 11 mAh/cm² in certain variations. Thus, active material loading may be improved when compared to commercial lithium-ion batteries, which typically have an active material loading of about 3 to 4 mAh/cm².

The negative electrode according to certain aspects of the present disclosure may have a first specific capacity of greater than or equal to about 1250 mAh/g and less than or equal to about 1500 mAh/g. Thus, the specific capacity is improved when compared a graphite electrode, which has a first specific capacity of about 372 mAh/g. Energy density can be optimized by varying porosity and thickness of the electrode. Porosity may be greater than or equal to about 20% and less than or equal to about 90%, optionally less than or equal to about 70%, by way of non-limiting example. Pore size may be proportional to active material particle size. Thickness may be greater than or equal to about 50 μm and less than or equal to about 200 μm, optionally less than or equal to about 130 μm, by way of non-limiting example.

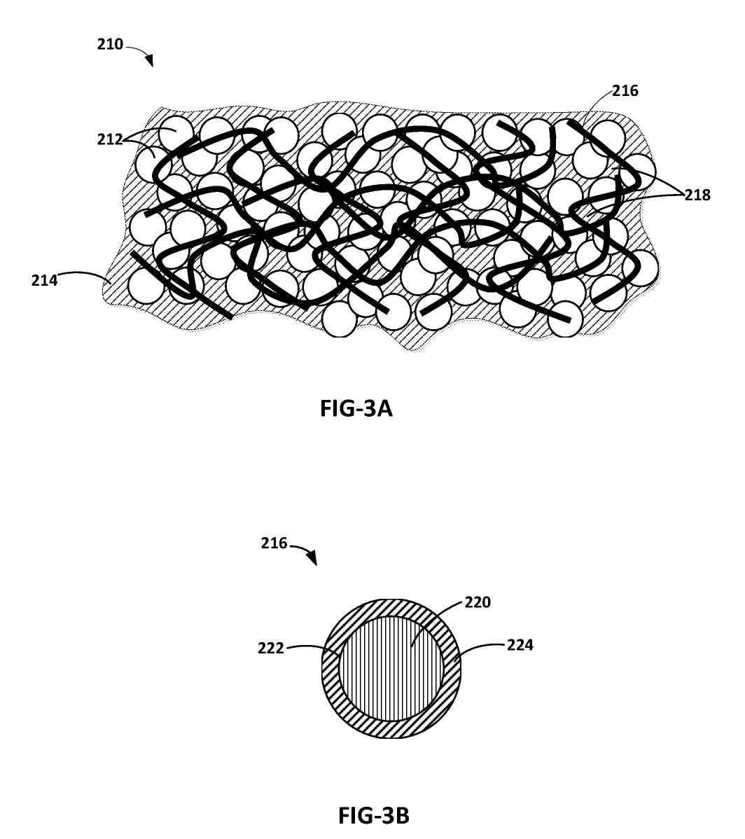

In certain other aspects, the present disclosure provides another negative electrode material 210. Referring to FIG. 3A, the electrode material 210 includes electroactive material 212, and a binder 214, similar to the electroactive material 112 and the binder 116 of FIG. 2, respectively. The electrode material 210 further includes a conductive porous hydrophilic substrate 216 having a plurality of voids 218. The electroactive materials 212 are dispersed in at least a portion of the voids 218. With reference to FIG. 3B, the conductive substrate 216 includes a porous hydrophilic substrate 220 having an outer surface 222. The outer surface 222 is coated in an electrically conductive material 224. The electrically conductive material 224 may include conductive metallic coatings, conductive polymer coatings, or carbonaceous coatings, by way of example. Conductive polymers include polyacetylenes (PAC), polypyrroles (PPY), and polyanilines (PANI), by way of non-limiting example. In certain other aspects, an electrode material may include both electrically conductive particles, as shown in FIG. 2, and a coated conductive porous hydrophilic substrate, as shown in FIGS. 3A-3B.

The conductive porous hydrophilic substrate 216 offers several advantages when the electrode material 210 is used in an electrochemical cell. The conductive substrate 216 may improve electrode performance by reducing the current path from electrode framework to the active materials, thereby reducing internal cell resistance. The electrically conductive coating 224 may also reduce the amount of electrically conductive filler particles, or eliminate them completely as shown in FIG. 3A. In certain aspects, the conductive substrate 216 may also serve as a current collector in the electrochemical cell.

In some aspects, the porous structure of the substrate enables the stacking of multiple electrodes in a single coin cell (not shown). Electrolyte can flow through the voids in the substrate, thereby increasing the amount of active material per coin cell. An electrode according to certain aspects of the present disclosure may be used with a foil current collector, a mesh current collector, or a tab-free current collector, by way of non-limiting example.

In still other aspects, the present disclosure provides a method of making a negative electrode for an electrochemical cell. The method includes applying a slurry including water, a binder, and an electroactive material to at least one side of a porous hydrophilic substrate to form a coated substrate. The slurry may be applied to the substrate by casting, dip-coating, or stray-deposition processes, by way of non-limiting example. The slurry coat may be relatively uniform. The binder and electroactive material may be similar to the binder 116 and electroactive material 112 of FIG. 2. The substrate may include cellulose (C₆H₆O₅)ₙ or derivatives thereof, similar to the substrate 118 of FIG. 2. The slurry may be applied to one side or multiple sides of the conductive substrate. When the slurry is applied to multiple sides of the substrate, the coated substrate may be dried between coating a first side and a second side. The slurry may fill some or all of a plurality of voids in the substrate.

The method further includes drying the coated substrate to form the negative electrode. The drying step may be done at temperatures greater than or equal to about 60° C. and less than or equal to about 90° C. for a duration of greater than or equal to about 4 hours and less than or equal to about 16 hours.

Forming the slurry may include admixing a binder precursor and water to create a binder solution. The water and binder may be stirred until the binder is dissolved. Stirring may have a duration of greater than or equal to about 1 minute and less than or equal to about 15 minutes. It may also be sonicated for greater than or equal to about 30 minutes and less than or equal to about 90 minutes to ensure complete dissolution of the binder in the water. The electroactive material may be added to the binder solution to form the slurry. The slurry may be stirred for greater than or equal to about 1 minute and less than or equal to about 15 minutes. The slurry may also be sonicated for greater than or equal to about 30 minutes and less than or equal to about 90 minutes.

When an electrically conductive filler material is used, the electrically conductive material and the electroactive material may be admixed to form a particle mixture prior to making the slurry. The electroactive material may be present at greater than or equal to about 50% by mass of the slurry and less than or equal to 90% by mass of the slurry, optionally 70% by mass of the slurry. The binder may be present at greater than or equal to about 0.5% by mass of the slurry and less than or equal to 50% by mass of the slurry, optionally 7.5% by mass of the slurry. The electrically conductive material may be present at greater than or equal to about 0.5% by mass of the slurry and less than or equal to 50% by mass of the slurry, optionally 22.5% by mass of the slurry.

The method may further include applying a conductive surface coating to one or more surface regions of the porous hydrophilic substrate to form a conductive hydrophilic substrate. The coating process may be selected from the group consisting of: atomic layer deposition (ALD), physical vapor deposition (PVD), chemical vapor deposition (CVD), chemical vapor infiltration, wet chemistry, and combinations thereof. In other aspects, the porous hydrophilic substrate may be pyrolized to form carbon black. Pyrolyzing may take place at temperatures of greater than or equal to about 600° and less than or equal to about 700° C.

### EXAMPLE 1

Silicon monoxide (SiO) electrode slurries are prepared by first dissolving 125 mg of sodium alginate (NaC₆H₉O₇) binder (Sigma Aldrich) into 10 ml of deionized water. The mixture is mechanically stirred until mostly dissolved and then sonicated for sixty (60) minutes to ensure complete dissolution of the binder to create a binder solution. A solid mixture of 1.4 g SiO powder (>99%, 325 mesh, Sigma Aldrich) and 0.425 g of Super-P C65 carbon black is coarsely mixed together to create a particle admixture. After sonication, the particle admixture is added to the binder solution and mechanically stirred for five (5) to ten (10) minutes. The binder solution and particle admixture are sonicated for an additional sixty (60) minutes to form a slurry. The prepared slurry is cast onto both sides of a 10×10 cm section of KIMWIPE®, which is used as the porous hydrophilic substrate, to form a coated substrate. A five (5) minute room temperature air drying step is included between flips of the substrate to prevent active material from sticking to the substrate upon which it was cast. The coated substrate is dried in air at 80° C. overnight and transferred into an argon (Ar) filled glovebox. Silicon metal anodes are prepared in an identical fashion (99.999%, 325 mesh, Alfa Aesar). Cell construction involves the use of a polypropylene separator coupled with 100 μL of 1M LiPF6 in EC/DEC and a lithium (Li) metal counter electrode. Only a single punched SiO anode is used for the cycling stability studies.

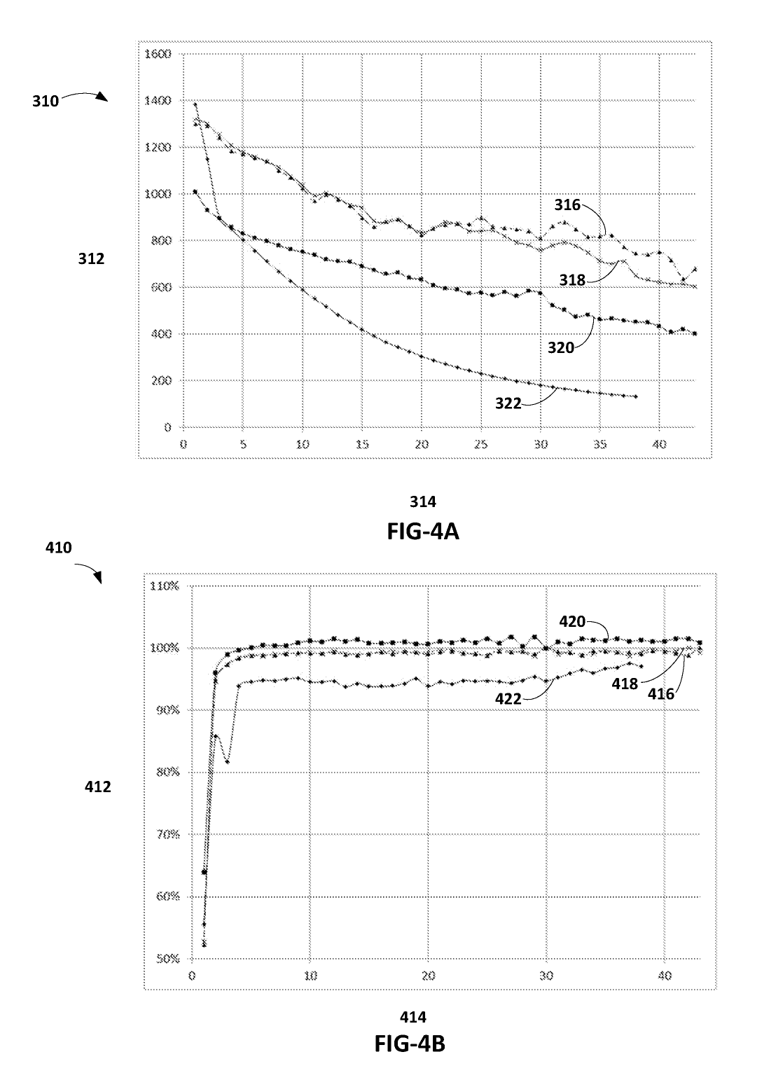

The above method is used to prepare a first electrode and a second electrode. The method is repeated, replacing the binder with sodium-CMC to create a third electrode. Referring to FIG. 4A, the electrochemical performance 310 of the various electrodes is shown. The y-axis 312 shows specific capacity in mAh/g and the x-axis 314 shows cycle number. The performance of the first electrode is shown at 316, performance of the second electrode is shown at 318, performance of the third electrode is shown at 320, and performance of a fourth electrode having a copper substrate rather than porous hydrophilic substrate is shown at 322. The first charge/discharge cycle includes reversible capacity of about 1250 mAh/g for the first and second electrodes 316, 318. However, the silicon monoxide material used in Example 1 is not designed for battery applications, thus, capacity may be improved with the use of battery-grade materials. For example, an electrode prepared with battery-grade materials may have a specific capacity of about 1500 mAh/g. Although the fourth electrode 322 has a similar reversible capacity after the first charge/discharge cycle, its performance drops below that of the first, second, and third electrodes 316, 318, 320 after three cycles.

Referring now to FIG. 4B, the Coulombic efficiency of various electrodes 410 is shown. The y-axis 412 shows Coulombic efficiency and the x-axis 414 shows cycle number. The efficiency of the first electrode is shown at 416, the efficiency of the second electrode is shown at 418, the efficiency of the third electrode is shown at 420, and the efficiency of the fourth electrode is shown at 422. The first charge/discharge cycle includes a Coulombic efficiency of about 50% for each of the first, second, and third electrodes 416, 418, 420. The low first cycle efficiency is due to both initial SEI layer formation and the creation of irreversible lithium silicates and oxides. However, the efficiency for the first, second, and third electrodes 416, 418, 420 rapidly approaches 100% on subsequent cycles, suggesting a stabilization of the irreversible reactions. Notably, the first efficiency may be about 70% when battery-grade materials are used. The Coulombic efficiency of the fourth electrode 422 is consistently low when compared to that of the first, second, and third electrodes 416, 418, 420.

### EXAMPLE 2

Using this substrate material, battery cell energy density is estimated in Wh/L if battery-grade materials are used for the cathode and the anode. A nickel-rich material is used as the electroactive material for the cathode and silicon monoxide material is used as the electroactive material for the anode. The silicon monoxide of the anode is dispersed in at least some of the voids of a cellulosic substrate. The anode has a specific capacity of 1600 mAh/g, pre-lithiated. The anode is assumed to have 50% porosity and 72% active material.

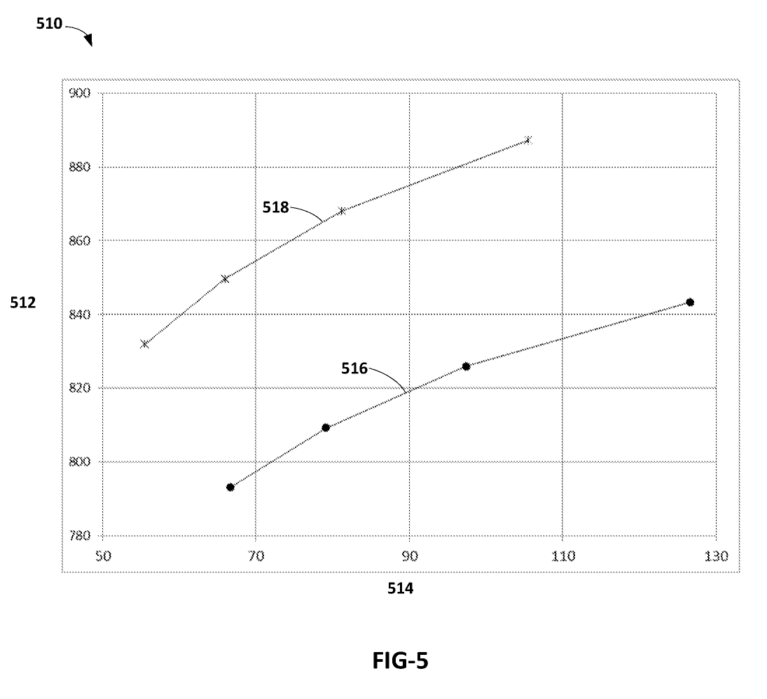

Referring now to FIG. 5, estimated energy density 510 is shown. The y-axis 512 shows energy density in Wh/L and the x-axis 514 shows anode coat thickness in μm. As shown in the graph 510, energy density greater than 800 Wh/L is possible. Energy density of a first anode having 50% porosity is shown at 516 and energy density of a second anode having 40% porosity is shown at 518. The first anode 516 has a higher porosity and a lower energy density. The second anode has a lower porosity and a higher energy density. Furthermore, for both of the first and second electrodes, energy density increases as anode coat thickness increases. Thus, higher energy densities are possible with optimized electrode design.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode material for an electrochemical cell, the electrode material comprising:
a porous hydrophilic substrate comprising a plurality of voids;
an electroactive material;
an electrically conductive particle; and
a binder;
wherein the electroactive material and the electrically conductive particle are dispersed in at least a portion of the voids of the porous hydrophilic substrate.

2. The electrode material of claim 1, wherein the porous hydrophilic substrate comprises cellulose (C₆H₆O₅)ₙ or derivatives thereof.

3. The electrode material of claim 1, wherein the porous hydrophilic substrate has a porosity of greater than or equal to about 20 volume % and less than or equal to about 70 volume %.

4. The electrode material of claim 1, wherein the electrically conductive particle is selected from the group consisting of: carbon black, graphite, carbon fibers, carbon nanotubes, powdered nickel, metal particles, conductive polymers, and combinations thereof.

5. The electrode material of claim 1, wherein a surface of the porous hydrophilic substrate is at least partially coated in an electrically conductive material.

6. The electrode material of claim 1, wherein the binder is water soluble and is selected from the group consisting of: sodium alginate, xanthan gum, carboxy methyl cellulose (CMC), polyacrylic acid (PAA), and combinations thereof.

7. The electrode material of claim 1, wherein the electroactive material is selected from the group consisting of: silicon (Si), silicon monoxide (SiO), silicon dioxide (SiO₂), SiSn, SiFe, SiSnFe, SiSnAl, SiFeCo, germanium (Ge), germanium oxide (GeO₂), tin (Sn), tin oxide (SnO₂), iron oxide (Fe₂O₃), alloys, and combinations thereof.

8. A lithium-ion electrochemical cell comprising:
a negative electrode comprising a porous hydrophilic substrate including a plurality of voids and comprising cellulose or a derivative thereof, a negative electroactive material, an electrically conductive particle, and a binder;
a positive electrode comprising a positive electroactive material comprising a transition metal;
a separator; and
an electrolyte;
wherein the electroactive material and the electrically conductive particle are dispersed in at least a portion of the voids of the porous hydrophilic substrate.

9. The electrochemical cell of claim 8, wherein the electrically conductive particle is selected from the group consisting of: carbon black, graphite, carbon fibers, carbon nanotubes, powdered nickel, metal particles, conductive polymers, and combinations thereof.

10. The electrochemical cell of claim 8, wherein a surface of the porous hydrophilic substrate is at least partially coated in an electrically conductive material.

11. The electrochemical cell of claim 8, wherein the negative electrode is capable of an active material loading of greater than or equal to about 7 mAh/cm² and less than or equal to about 11 mAg/cm².

12. The electrochemical cell of claim 8, wherein the negative electrode has a specific capacity of greater than or equal to about 700 mAh/g after 40 cycles of lithium ion intercalation and deintercalation in the negative electrode of the electrochemical cell.

13. The electrochemical cell of claim 8, wherein the negative electrode has a thickness of greater than or equal to about 50 μm and less than or equal to about 130 μm.

14. A method of making a negative electrode for an electrochemical cell,
the method comprising:
applying a slurry comprising water, a binder, and an electroactive material, and an electrically conductive particle to at least one side of a porous hydrophilic substrate comprising cellulose or a derivative thereof to form a coated porous substrate; and
drying the porous coated substrate to form the negative electrode.

15. The method of claim 14, further comprising forming the slurry, wherein forming the slurry comprises:
admixing a binder precursor and water to create a binder solution;
admixing the electroactive material and the electrically conductive particle to form a particle admixture; and
adding the particle admixture to the binder solution to form the slurry.

16. The method of claim 14, wherein forming a coated porous substrate comprises applying the slurry to two sides of the porous hydrophilic substrate.

17. The method of claim 14, further comprising applying a conductive surface coating to one or more surface regions of the porous hydrophilic substrate in a process selected from the group consisting of: atomic layer deposition (ALD), physical vapor deposition (PVD), chemical vapor deposition (CVD), chemical vapor infiltration, wet chemistry, and combinations thereof.

18. The method of claim 14, wherein the electroactive material is present in the porous hydrophilic substrate at greater than or equal to about 50% by mass and less than or equal to about 99% by mass of the slurry, the binder is present at greater than or equal to about 0.5% by mass and less than or equal to about 50% by mass of the slurry, and the electrically conductive particle is present at greater than or equal to about 0.5% by mass and less than or equal to about 50% by mass of the slurry.

19. The method of claim 14, wherein the porous hydrophilic substrate comprises cellulose (C₆H₆O₅)ₙ or derivatives thereof.

20. The method of claim 14, wherein the electroactive material is selected from the group consisting of: silicon (Si), silicon monoxide (SiO), silicon dioxide (SiO₂), SiSn, SiFe, SiSnFe, SiSnAl, SiFeCo, germanium (Ge), germanium oxide (GeO₂), tin (Sn), tin oxide (SnO₂), iron oxide (Fe₂O₃), alloys, and combinations thereof.
